(19) United States
(12) Patent Application Publication
(10) Pub. No.: US 2005/0045434 A1
(43) Pub. Date: Mar. 3, 2005

(54) Vehicle brake assembly having an assembly opening and method of assembly therefor

(76) Inventors: Franz-Helmut Holl, Mastershausen (DE); Juergen Dreher, Muelheim-Kaerlich (DE)

Correspondence Address: CARLSON, GASKEY & OLDS, P.C., 400 WEST MAPLE ROAD, SUITE 350, BIRMINGHAM, MI, 48009, US

(21) Appl. No.: 10/405,327

(22) Filed: Apr. 2, 2003

(51) Int. Cl. F16D 55/08

(52) U.S. Cl. 188/72.1

(57) ABSTRACT

A vehicle brake assembly includes a first brake housing portion having an assembly opening formed through a lower face. The lower face is substantially perpendicular to a front face which faces a brake rotor. Bearing blocks, needle bearings, and a lever assembly are passed through the assembly opening. A brake actuation mechanism, closing plate, and a second housing portion are assembled to the first housing. The addition of the assembly opening perpendicular to the front face provides greater flexibility with regard to accommodating specific assembly line sequence requirements.

### BACKGROUND OF THE INVENTION

The present invention relates to a vehicle brake assembly and, more particularly, to a brake housing having a dedicated assembly opening and a method of assembly therefor.

Disc brake assemblies typically include a disc brake caliper that houses a piston for forcing a pair of friction elements or brake pads into engagement with a rotor. Heavy-duty vehicle brake assemblies commonly include multiple pistons that are actuated by a cam manipulated by a pneumatic actuator. The heavy-duty brake assemblies may be relatively complicated compared to passenger vehicle brake assemblies and may be specifically tailored to particular heavy vehicle applications.

Various assembly line sequence limitations may require later assembly of certain brake mechanism components within the housing. One assembly line sequence limitation may be the desire to manufacture each brake assembly in an identical manner and assemble unique components for specific vehicle applications at final assembly stages to minimize tracking each brake assembly through the entire assembly process.

Disadvantageously, a relatively large number of individual brake components may already be assembled by the time the brake assembly reaches the final assembly stages. Assembly limitations stemming from the previously assembled components may then have to be addressed by utilizing different and perhaps small or less convenient housing openings to assemble the remaining components.

Accordingly, it is desirable to provide a vehicle brake assembly which allows unique component installation during the final assembly stages while maintaining component reliability.

### SUMMARY OF THE INVENTION

The vehicle brake assembly according to the present invention provides a brake housing having an assembly opening formed through a lower face. The lower face is substantially perpendicular to a front face which faces toward a brake rotor.

An assembly sequence for the present invention utilizes the assembly opening. Bearing blocks are passed through the assembly opening and located upon bearing block seats. Needle bearings are located upon the bearing blocks to receive a cam surface of a lever assembly. A brake mechanism, closing plate, and another housing portion are then assembled to the first housing portion.

An assembly opening closing plate finally closes the assembly opening. The assembly opening closing plate is a stamped metal component that is pressed into the assembly opening to seal the housing portion.

The assembly opening perpendicular to the front face provides additional flexibility with regard to accommodating specific assembly line sequence requirements. Moreover, the assembly opening closing plate is relatively easily removed to access the interior of the housing portion without disassembly of other components therefrom. Alternative maintenance advantages are thereby provided.

The present invention therefore provides a vehicle brake assembly which allows unique component installation during the final assembly stages while maintaining component reliability.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross-sectional end view of a vehicle brake assembly of the present invention;

FIG. 2 is a cross-sectional top elevation view of the present invention;

FIG. 3 is a front exploded perspective view of a housing portion having an assembly opening; and

FIG. 4 is a rear exploded perspective view of the housing portion of FIG. 3.

### DETAILED DESCRIPTION OF THE PREFERRED EMBODIMENT

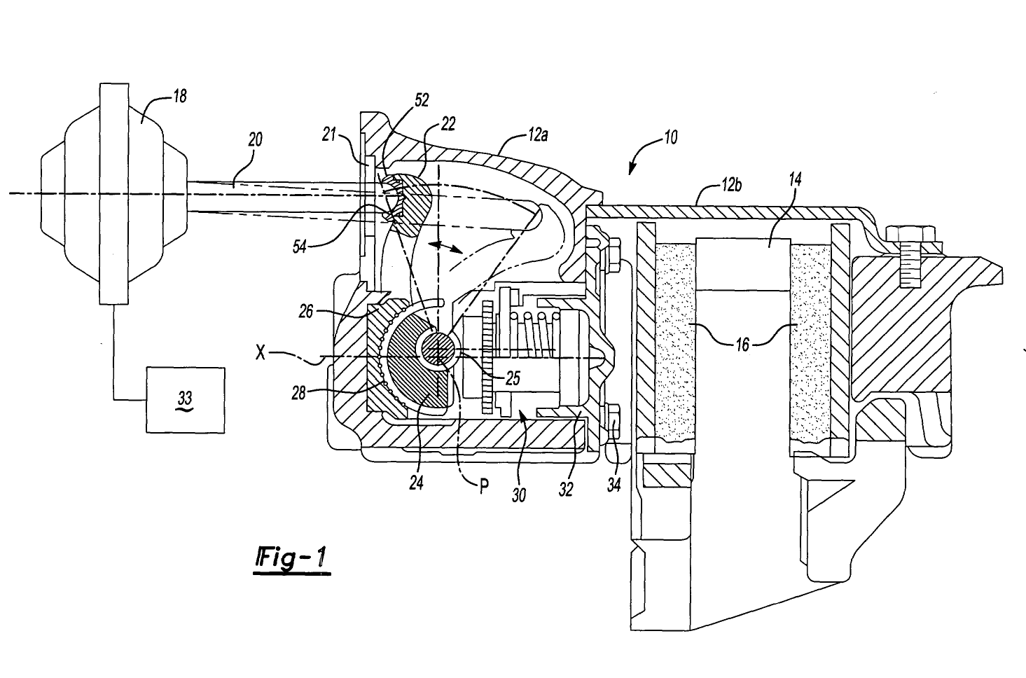

FIG. 1 illustrates a general sectional view of a vehicle brake assembly 10. The vehicle brake assembly 10 includes a housing 12 that may be constructed from one or more housing portions 12a, 12b. A rotor 14 is arranged within the housing portion 12b which at least partially contains a set of brake pads 16, or friction elements, arranged on either side of a brake rotor 14.

An actuator 18, typically an air chamber, actuates a brake actuation mechanism 30 to force the brake pads 16 into engagement with the rotor 14. The actuator 18 drives a push rod 20 through a push rod opening 21 to rotate a lever assembly 22 about a pivot axis p. The lever assembly 22 includes a cam 24 having a profile 25 that cooperates with a pair of bearing blocks 26 and a brake actuation mechanism 30. The cam 24 is received at least partially within the bearing blocks 26 and supported by a plurality of needle bearings 28 within the housing 12 such that the cam 24 moves in an eccentric actuating arrangement relative the bearing blocks 26 to drive the brake actuation mechanism 30 and the brake pads 16. It should be understood that various actuating systems which are operated by a lever will benefit from the present invention.

An opening 31 of the housing portion 12a is closed off on the front face 29. That is, the front face 29 is positioned to face the brake rotor 14. A closing plate 32 which may at least partially support the brake actuation mechanism 30 closes the opening 31. The closing plate 32 is attached to the housing 12 by fasteners 34 or the like. Sealing elements are preferably located upon the sealing surfaces between the closing plate 32 and the housing 12a.

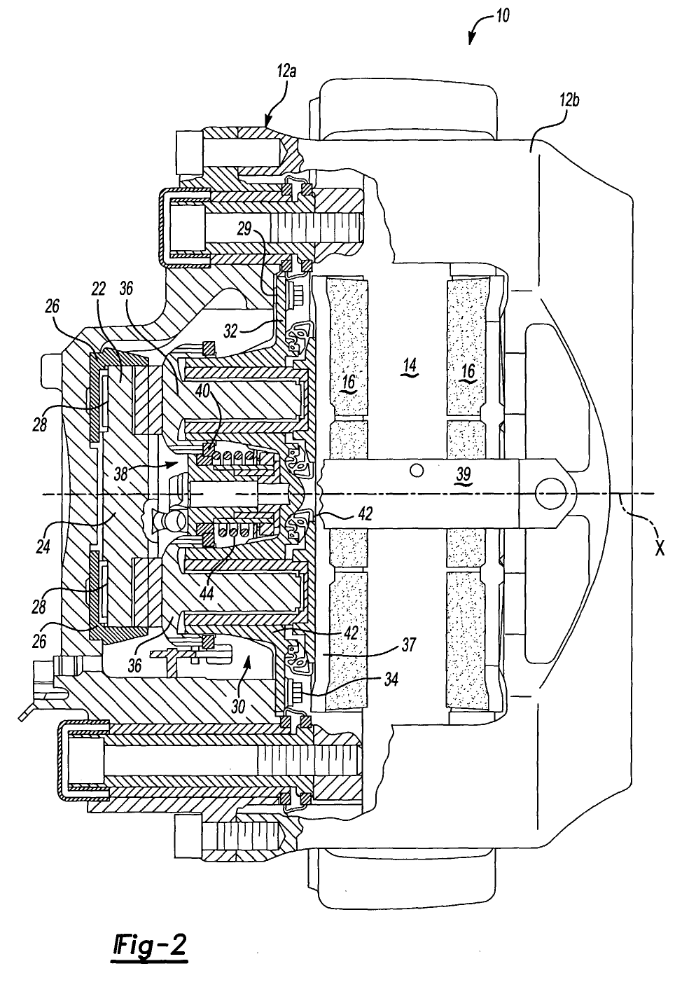

In operation, upon actuation of the brake pedal by the vehicle operator, an electrical signal is produced by a control module 33 to energize the actuator 18. Heavy-duty vehicle brake assemblies typically include a pair of pistons 36 (FIG. 2) that transmit the force generated by the actuator 18 through the push rod 20, the lever assembly 22, and the brake actuation mechanism 30. It is to be understood that any suitable number of pistons 36 may be used.

Referring to FIG. 2, the pistons 36 drive an actuating plate 37 which drives the brake pads 16 into engagement with the rotor 14. A linkage 39 is connected to the brake mechanism 30 to the outer brake pad 16. The actuating plate 37 moves relative the closing plate 32 and is sealed therewith through a seal 42.

After the brakes are actuated, the brake pads 16 must be retracted to prevent the brake pads 16 from dragging on the rotor 14. To this end, a return assembly 38 operates to retract the pistons 36. The return assembly 38 generally includes a plate 40 adjacent to a return spring 44. The return spring 44 is arranged between a portion of the housing 12a and the plate 40. The return spring 44 applies a force opposite the actuation force to the plate 40 and into the pistons 36 to retract the actuating plate 37 and the brake pads 16.

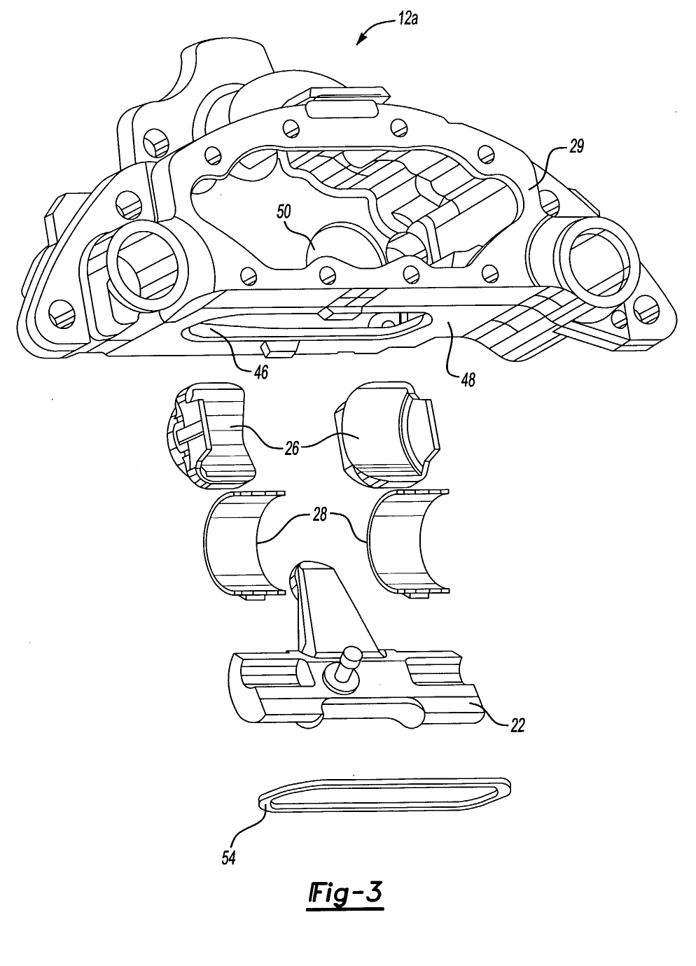

Referring to FIG. 3, an assembly opening 46 is formed through the lower face 48 of housing portion 12a. The lower face 48 is substantially perpendicular to the front face 29. It should be understood that relative positional terms such as “front,” “aft,” “upper,” “lower,” “above,” “below,” and the like are with reference to the normal operational attitude of the vehicle and should not be considered otherwise limiting.

The assembly opening 46 is preferably through a substantially non-structural portion of the brake housing portion 12a and is sized to receive the lever assembly 22. It should be understood that various opening shapes will benefit from the present invention.

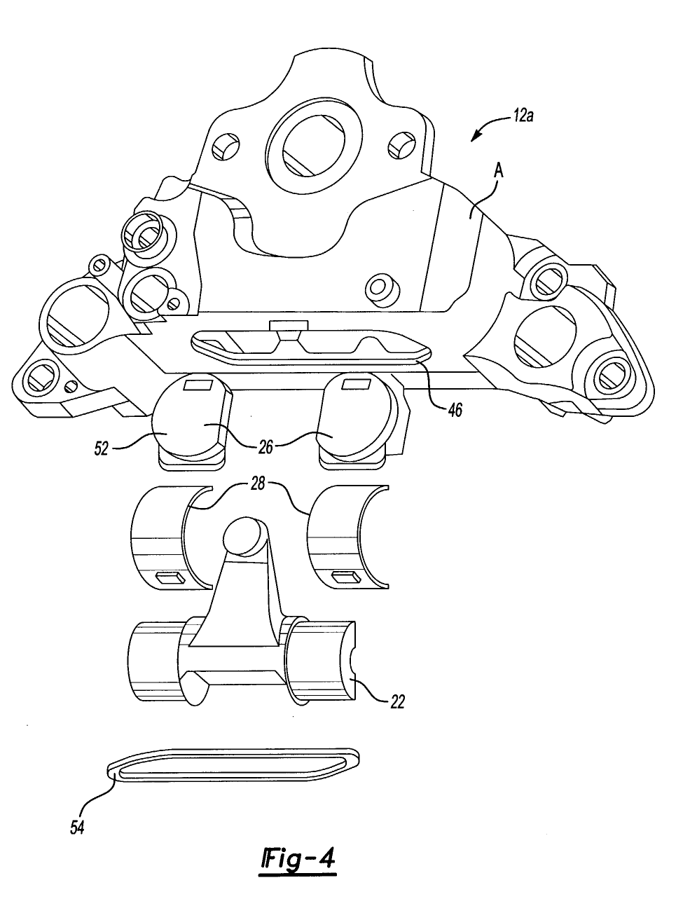

An assembly sequence for the present invention utilizes the assembly opening 46. The bearing blocks 26 are passed through the assembly opening 46 and located upon bearing block seats 50. The bearing block seats 50 are preferably circular depressions that receive corresponding mating surfaces 52 (FIG. 4) extending from each of the bearing blocks 26. The needle bearings 28 are then located upon the bearing blocks 26 to receive the cam surface 24 of the lever assembly 22. The brake actuation mechanism 30, closing plate 32, and housing portion 12b may then be assembled to housing portion 12a (FIGS. 1 and 2).

An assembly opening closing plate 54 is utilized to close the assembly opening 46. Assembly opening closing plate 54 is preferably a stamped metal component that is pressed into the assembly opening 46 to seal the housing portion 12a.

It should be understood that various assembly line sequence requirements may require assembly of the bearing blocks 26, needle bearings 28, and/or the lever assembly 22 through the assembly opening 46. The addition of the assembly opening 46 perpendicular to the front face 29 provides additional flexibility with regard to accommodating specific assembly line sequence requirements. Moreover, assembly opening closing plate 54 is relatively easily removed to access the interior of housing portion 12a without disassembly of the housing portion 12b or other components therefrom. Alternative maintenance advantages are thereby provided.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vehicle brake assembly comprising:
a first brake housing portion comprising a first opening through a first face and an assembly opening through a second face, said second face substantially perpendicular to said first face; and
a second brake housing portion mountable to said first brake housing portion adjacent said first face.

2. The vehicle brake assembly as recited in claim 1, wherein said assembly opening is of a size to receive a lever assembly.

3. The vehicle brake assembly as recited in claim 1, wherein said assembly opening is of a size to receive a bearing block.

4. The vehicle brake assembly as recited in claim 1, wherein said second brake housing portion at least partially contains a brake pad.

5. The vehicle brake assembly as recited in claim 1, wherein said second brake housing portion at least partially contains a brake rotor.

6. The vehicle brake assembly as recited in claim 1, wherein said second brake housing portion at least partially contains a brake actuation mechanism.

7. The vehicle brake assembly as recited in claim 6, wherein said assembly opening is of a size which permits receipt of said brake actuation mechanism.

8. The vehicle brake assembly as recited in claim 1, further comprising an assembly opening closing plate to close said assembly opening.

9. The vehicle brake assembly as recited in claim 1, further comprising an assembly opening closing plate press fit into said assembly opening.

10. The vehicle brake assembly as recited in claim 1, further comprising a stamped metal assembly opening closing plate press fit into said assembly opening.

11. A method of assembling a vehicle brake housing comprising the steps of:
(1) assembling a lever assembly through an assembly opening located substantially perpendicular to a first opening through a first face of a first brake housing portion;
(2) assembling a second brake housing portion to said first brake housing portion adjacent said first face.

12. A method as recited in claim 1 1, further comprising the steps of:
assembling a brake actuation mechanism through said first opening.
